(19) United States
(12) Patent Application Publication
(10) Pub. No.: US 2008/0120056 A1
(43) Pub. Date: May 22, 2008

(54) ANGULAR VELOCITY CALIBRATION METHOD

(76) Inventors: Masami Haino, Tokyo (JP); Takanori Miki, Kanagawa (JP)

Correspondence Address: Frank Pincelli;Patent Legal Staff, Eastman Kodak Company, 343 State Street, Rochester, NY, 14650-2201, US

(21) Appl. No.: 11/740,313

(22) Filed: Apr. 26, 2007

(30) Foreign Application Priority Data
Nov. 16, 2006 (JP) 2006-310676

(51) Int. Cl. G01P 21/00

(52) U.S. Cl. 702/96

(57) ABSTRACT

Inclinations of angular velocity sensors attached to a camera are detected, and outputs from the angular velocity sensors are calibrated. A camera is placed on a rotating table and rotated, angular velocities are detected by angular velocity sensors, and a CZP chart is photographed. The motion of the camera is expressed as a locus of motion of a point light source on an imaging plane from the outputs from the angular velocity sensors. The inclination of the locus motion is compared with the inclination of a zero-crossing line which has been obtained by subjecting the photographed image to Fourier transformation, to thus compute angles of relative inclination of the angular velocity sensors with respect to the image sensor.

### CROSS REFERENCE TO RELATED APPLICATIONS

This application claims priority to Japanese Patent Application No. 2006-310676 filed on Nov. 16, 2006, which is incorporated herein by reference in its entirety.

### FIELD OF THE INVENTION

The present invention relates to a method for calibrating an axis for detecting an angular velocity in a camera having an angular velocity detection system.

### BACKGROUND OF THE INVENTION

When angular velocity sensors, such as gyroscopic sensors or the like, are used, locations where the angular sensors are mounted or a mount angle must be adjusted with high accuracy. However, difficulty is encountered in ensuring accuracy for all of a plurality of mass-produced articles during an actual mounting process. There may arise a case where an inclination occurs during mounting of the angular velocity sensors, whereby outputs from the angular velocity sensors differs from a value which should be output originally. In a digital camera, the angular velocity sensors are used primarily for preventing occurrence of camera shake and is materialized by a method for actuating an optical lens in accordance with outputs from the angular velocity sensors, oscillating an image sensor, and the like. In order to prevent camera shake with high accuracy, the motion of the camera achieved during camera shake must be accurately determined from an output from the angular velocity sensor.

Japanese Patent Laid-Open Publication No. Hei-5-14801 describes determining a differential motion vector in each field from an image signal output from a CCD; detecting an angular velocity of zero from the differential motion vector; and setting an offset voltage in accordance with a result of detection.

Japanese Patent Laid-Open Publication No. Hei-5-336313 describes determining a point spread function pertaining to an image signal output from a line sensor, and electrically correcting a positional displacement of the line sensor by means of the point spread function.

However, none of the above-described techniques are sufficient for calibrating the inclinations of the angular velocity sensors with high accuracy. In particular, when the angular velocity sensors are used for preventing occurrence of camera shake, high-accuracy calibration of an inclination is required. Moreover, since there is a potential of the image sensor also remaining inclined, calibration must be performed in consideration of the inclination of the image sensor.

### SUMMARY OF THE INVENTION

The present invention detects, computes, and calibrates, with high accuracy, the inclination of an angular velocity sensor and the inclination of an image sensor, which are disposed in a camera.

The present invention provides a method for calibrating an angular velocity detection axis in a camera having an angular velocity detection system, the method comprising the steps of:

computing motion of the camera as a locus of motion of a point light source on an imaging plane from an angular velocity output acquired when the camera is rotated around a reference axis;

computing an inclination of the locus of motion; and

calibrating an output from the angular velocity sensor in accordance with the inclination.

Moreover, the present invention also provides an angular velocity calibration method comprising the steps of:

acquiring outputs from angular velocity sensors for detecting an angular velocity around an X axis and an angular velocity around a Y axis when a camera is rotated around the X axis penetrating through the camera horizontally and around the Y axis which is perpendicular to the X axis and which penetrates through the camera vertically;

photographing a predetermined image during rotation of the camera;

computing motion of the camera from the output as a locus of motion of a point light source on an imaging plane;

computing inclination of the angular velocity sensor from the inclination of the locus of motion;

computing inclination of the image sensor of the camera from the photographed image;

computing an angle of relative inclination of the angle of the angular velocity sensor with respect to the image sensor, from the inclination of the angular sensor and the inclination of the angular velocity sensor;

calibrating outputs from the angular velocity sensor from the angle of relative inclination; and

recomputing the locus of motion of the point of light source on the imaging sensor from the calibrated output from the angular velocity sensor, thereby further computing a point spread function (PSF). Here, the PSF is an expression of the locus of motion as a brightness distribution function for each of the pixels of the image sensor.

According to the present invention, inclinations between the angular velocity sensors attached to the camera and the image sensor are computed and detected with high accuracy. Moreover, an output from the inclined angular velocity sensor is calibrated, whereby an accurate angular velocity can be acquired. Calibrating an angular velocity by means of the present invention leads to an advantage of an improvement in, e.g., the accuracy in preventing camera shake, which would otherwise arise during photographing.

The invention will be more clearly comprehended by reference to the embodiment provided below. However, the scope of the invention is not limited to the embodiment.

### BRIEF DESCRIPTION OF THE DRAWINGS

A preferred embodiment of the present invention will be described in detail based on the following figures, wherein:

FIG. 1 is a schematic view showing the basic configuration of an angular velocity detection system of an embodiment achieved when a camera is rotated in a yaw direction;

FIG. 2 is a schematic view showing the basic configuration of the angular velocity detection system of the embodiment achieved when the camera is rotated in a pitch direction;

FIG. 3 is a descriptive view of an output from a gyroscopic sensor when the camera is rotated in the yaw direction (around a Y axis);

FIG. 4 is a descriptive view of an output from the gyroscopic sensor when the camera is rotated in the pitch direction (around an X axis);

FIG. 5 is a descriptive view of an output from the gyroscopic sensor for the yaw direction when the camera is rotated in both the yaw direction and the pitch direction;

FIG. 6 is a descriptive view of an output from the gyroscopic sensor for the pitch direction when the camera is rotated in both the yaw direction and the pitch direction;

FIG. 7A is a plot showing changes in the output from the gyroscopic sensor for the yaw direction appearing when the camera is rotated in the yaw direction;

FIG. 7B is a plot showing changes in the output from the gyroscopic sensor for the pitch direction appearing when the camera is rotated in the yaw direction;

FIG. 7C is a plot showing the locus of motion of a point light source on an imaging plane acquired when the camera is rotated in the yaw direction;

FIG. 8A is a plot showing changes in the output from the gyroscopic sensor for the yaw direction appearing when the camera is rotated in the pitch direction;

FIG. 8B is a plot showing changes in the output from the gyroscopic sensor for the pitch direction appearing when the camera is rotated in the pitch direction;

FIG. 8C is a plot showing the locus of motion of a point light source on an imaging plane acquired when the camera is rotated in the pitch direction;

FIG. 9A is a plot showing changes in the calibrated output from the gyroscopic sensor for the yaw direction appearing when the camera is rotated in the yaw direction;

FIG. 9B is a plot showing changes in the calibrated output from the gyroscopic sensor for the pitch direction appearing when the camera is rotated in the yaw direction;

FIG. 9C is a plot showing the calibrated locus of motion of a point light source on an imaging plane acquired when the camera is rotated in the yaw direction;

FIG. 10A is a plot showing changes in the calibrated output from the gyroscopic sensor for the yaw direction appearing when the camera is rotated in the pitch direction;

FIG. 10B is a plot showing changes in the calibrated output from the gyroscopic sensor for the pitch direction appearing when the camera is rotated in the pitch direction;

FIG. 10C is a plot showing the calibrated locus of motion of a point light source on an imaging plane acquired when the camera is rotated in the pitch direction;

FIG. 11 is a basic flowchart of the angular velocity detection system of the embodiment;

FIG. 12 is a detailed schematic view of the angular velocity detection system of the embodiment;

FIG. 13 is a detailed flowchart (part 1) of the angular velocity detection system of the embodiment;

FIG. 14 is a detailed flowchart (part 2) of the angular velocity detection system of the embodiment;

FIG. 15 is a descriptive view of a PSF acquired when the camera is rotated in the yaw direction;

FIG. 16 is a descriptive view of the PSF acquired when the camera is rotated in the pitch direction;

FIG. 17 is a descriptive view of a photographed image during rotation of the camera in the yaw direction and a result of Fourier transformation of a yet-to-be-calibrated PSF;

FIG. 18 is a descriptive view of a photographed image during rotation of the camera in the pitch direction and a result of Fourier transformation of the yet-to-be-calibrated PSF;

FIG. 19 is a descriptive view of a photographed image during rotation of the camera in the yaw direction and a result of Fourier transformation of a calibrated PSF;

FIG. 20 is a descriptive view of a photographed image during rotation of the camera in the pitch direction and a result of Fourier transformation of a calibrated PSF; and

FIG. 21 is a descriptive view of double Fourier transformation of a photographed image of a CZP chart.

### DETAILED DESCRIPTION OF THE PREFERRED EMBODIMENT

An embodiment of the present invention will be described hereunder by reference to the drawings.

<Calculation of an Inclination of an Angular Velocity Sensor>

In the present embodiment, the inclination of a gyroscopic sensor attached, as an example of an angular velocity sensor, to a digital camera is computed by utilization of multi-axis sensitivity acquired when the digital camera is placed on top of a rotating table and rotated around only predetermined axes. The digital camera is assumed to be rotated around each of the rotational axes; e.g., a longitudinal direction (a pitch direction), a lateral direction (a roll direction), and a vertical axis (a yaw direction). At this time, when the rotating table is rotated in only the pitch direction, an output is to be output solely from a gyroscopic sensor which is attached to the digital camera and detects an angular velocity of the pitch direction. However, when the gyroscopic sensor is attached at an angle, an angular velocity of the yaw direction is also output. Acquisition of angular velocities in several directions is known as multi-axis sensitivity, and the inclination of the gyroscopic sensor is computed by use of outputs appearing on the multiple axes.

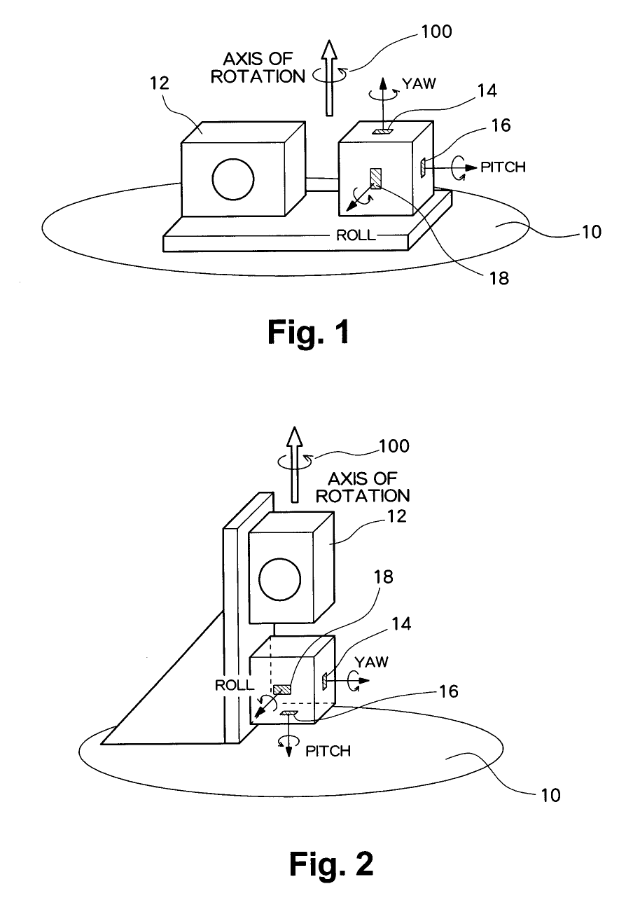

FIG. 1 shows a basic configuration acquired when the inclination of the gyroscopic sensor is detected. A camera 12 and gyroscopic sensors 14, 16, and 18 are mounted on a rotating table 10. The gyroscopic sensor 14 detects an angular velocity in the yaw direction of the camera 12; the gyroscopic sensor 16 detects an angular velocity of the pitch direction of the camera; and the gyroscopic sensor 18 detects an angular velocity in the roll direction of the same. In order to make descriptions easy to understand, the camera 12 and the gyroscopic sensors 14, 16, and 18 are separately illustrated in the drawing. Needless to say, the gyroscopic sensors 14, 16, and 18 may also be set within the camera 12. In FIG. 1, the camera 12 and the gyroscopic sensors 14, 16, and 18 are rotated in the yaw direction; namely, the direction of arrow 100, as a result of rotation of the rotating table 10. FIG. 2 shows a state where the camera 12 and the gyroscopic sensors 14, 16, and 18 are mounted on the rotating table 10 while remaining turned through 90° in FIG. 1. In this state, the camera 12 and the gyroscopic sensors 14, 16, and 18 are rotated in the pitch direction as a result of rotation of the rotating table 10.

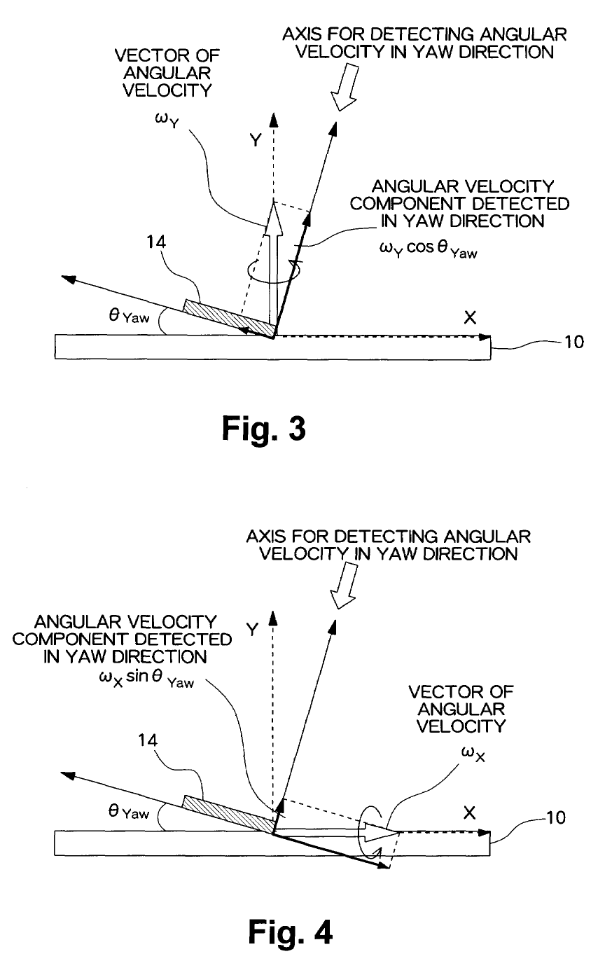

FIG. 3 shows an angular velocity vector component acquired when the gyroscopic sensor 14 belonging to the configuration shown in FIG. 1 is inclined. A detection axis of the gyroscopic sensor 14 for detecting an angular velocity in the yaw direction is inclined at θyaw, and an angular velocity ωY to be originally detected is detected as ωYcosθyaw. Further, FIG. 4 shows an angular velocity vector component acquired when the gyroscopic sensor 14 belonging to the configuration shown in FIG. 2 is inclined. When the detection axis of the gyroscopic sensor 14 that detects an angular velocity in the yaw direction is inclined at θyaw, there is detected ωXsinθyaw of ωX which should not originally be detected.

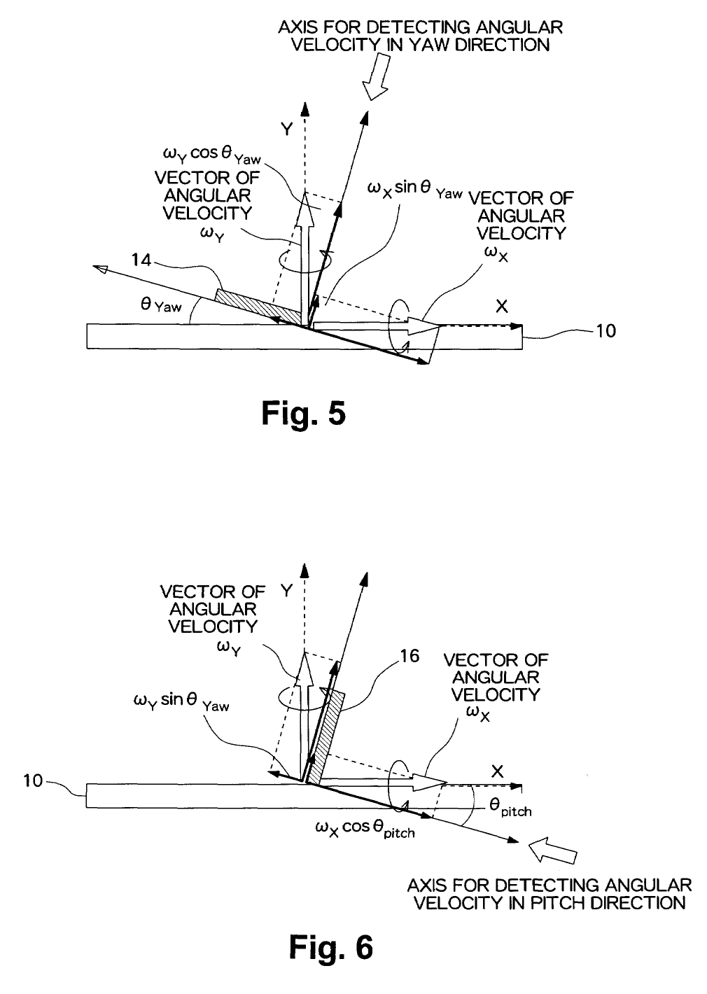

FIG. 5 shows, in combination, the angular velocity vector shown in FIG. 3 and the angular velocity vector shown in FIG. 4. An output ωyaw from the gyroscopic sensor 14 produced when ωX and ωY act on the gyroscopic sensor is expressed as

ωyaw=ωY cos θyaw+ωX sin θyaw.

Further, as shown in FIG. 6, when the detection axis of the gyroscopic sensor 16 that detects an angular velocity of the pitch direction is inclined at θpitch, an output ωpitch from the gyroscopic sensor 16 when ωX and ωY act on the gyroscopic sensor is expressed as

ωpitch=ωY sin θpitch+ωX cos θpitch.

From this equation, we have

ωX=(−ωyawsinθpitch+ωpitchcosθyaw)/cos(θyaw+θpitch), and

ωY=(ωyawcosθpitch−ωpitchsinθyaw)/cos(θyaw+θpitch).

Reference symbols ωX and ωY designate true angular velocities acquired when the gyroscopic sensors 14 and 16 are accurately attached without an inclination. Reference symbols ωyaw and ωpitch designate measured values which are outputs from the gyroscopic sensors 14 and 16. Consequently, so long as θyaw and θpitch can be acquired, ωX and ωY are determined from ωyaw and ωpitch. θyaw and θpitch can be computed from data to which the motion of the camera acquired from the outputs from the gyroscopic sensor 14 and 16 is represented as a locus of motion of a point light source on an imaging plane.

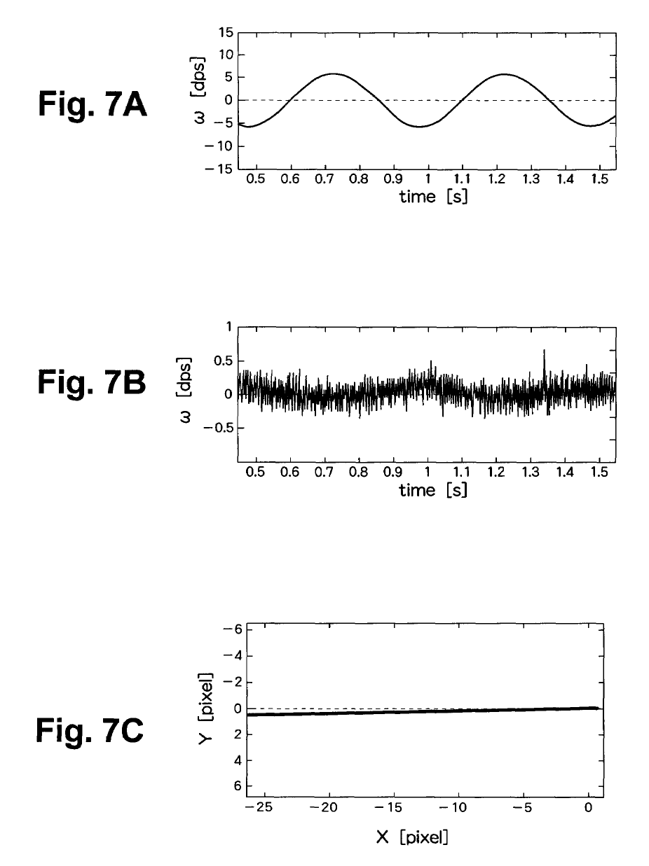

FIG. 7A shows changes with time in ωyaw output from the gyroscopic sensor 14 achieved when the rotating table 10 is rotated in the configuration shown in FIG. 1. FIG. 7B shows changes with time in ωpitch output from the gyroscopic sensor 16 achieved when the rotating table 10 is rotated under the same conditions.

### Provided that ωX=0 in the above equations ωyaw=ωY cos θyaw+ωX sin θyaw

ωpitch=ωY sin θpitch+ωX cos θpitch,

we have

ωyaw=ωY(t)cos θyaw

ωpitch=ωY(t)sin θpitch.

Provided that θyaw=5 deg. or thereabouts is achieved, cos θyaw=0.9961 is acquired, and hence cos θ yaw can be approximated to one. Therefore, we have

ωyaw=ωY(t)

ωpitch=ωY(t)sin θpitch.

In an ideal state where there is no inclination, ωpitch corresponds to 0. When there is an inclination, a changing wave shape attributable to sin θ pitch appears in ωpitch as shown in FIG. 7B. When ωyaw and ωpitch are sampled at a sampling frequency fs, the amounts of angular changes Δθx and Δθy per sampling time Δts, which is 1/fs, are defined as

Δθx=ωyaw·Δts=ωY(k)·Δts

Δθy=ωpitch·Δts=ωY(k)·Δts·sin θpitch,

where “k” is a sampling point. Over the entire period of time in which sampling has been performed, changes in rotational angle with time are defined as follows. Namely, we have

θx=Δts·ΣωY(k)

θy=Δts·sin θpitch·ΣωY(k).

Given that the motion of the camera is expressed as the amount of motion of the point light source on an imaging plane, the amounts of motions X and Y are computed as a product of a focal length “f” of the camera 12 and an angular displacement, and hence we have

X(k)=f·Δts·ΣωY(k)

Y(k)=f·Δts·sin θpitch·ΣωY(k).

FIG. 7C shows a locus (X, Y) of the point light source computed as mentioned above. The angle of inclination θpitch of the gyroscopic sensor 16 is given by

sin θpitch=Y(k)/X(k).

So long as the inclination K of the locus shown in FIG. 7C is computed, the inclination of the gyroscopic sensor 16 can be acquired. The inclination of the locus shown in FIG. 7C is computed by means of subjecting the inclination of the locus shown in FIG. 7C to linear approximation by means of the least square method. Since θpitch<<1 is generally considered to stand, sin θ pitch=θpitch is acquired, and finally θpitch=K is achieved.

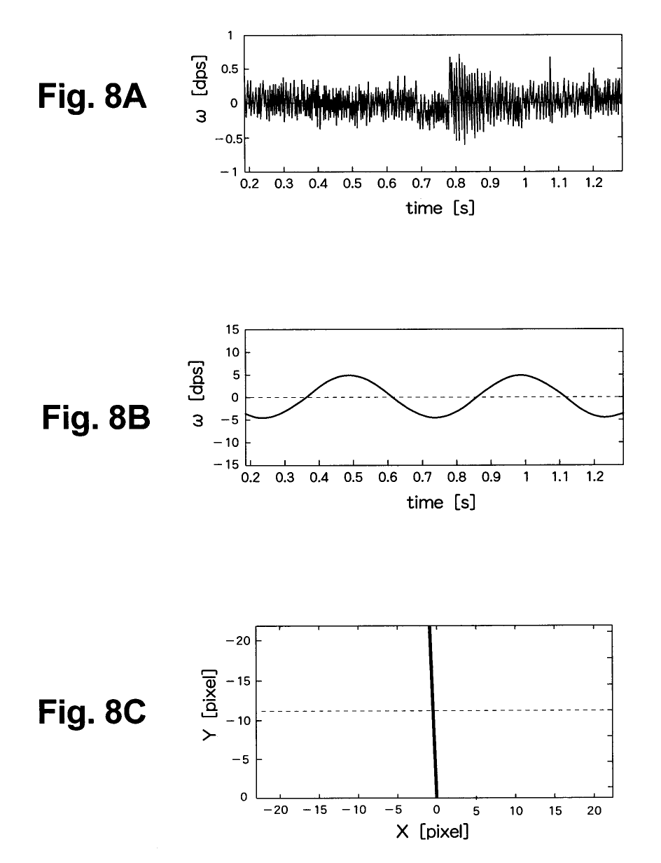

FIG. 8A shows changes with time in the output ωyaw of the gyroscopic sensor 14 achieved when the rotating table 10 is rotated in the configuration shown in FIG. 2. FIG. 8B shows changes with time in the output ωpitch of the gyroscopic sensor 16 achieved when the rotating table 10 is rotated under the same conditions. FIG. 8C shows a locus of the point light source on the imaging plane. Like the case shown in FIG. 7C, the inclination θyaw of the gyroscopic sensor 14 can be acquired, so long as the inclination L of the locus of the point light source is computed. Specifically, θyaw=L is acquired.

So long as θyaw and θpitch have been determined as mentioned above, angular velocities ωX and ωY of the rotating section of the rotating table, which should originally be output and where the inclinations θpitch and θyaw in two directions are calibrated by the following equations, are determined.

ωX=(−ωyawsinθpitch+ωpitchcosθyaw)/cos(θyaw+θpitch)

ωY=(ωyawcosθpitch−ωpitchsinθyaw)/cos(θyaw+θpitch)

### The locus of the point light source—from which the influence of the inclination of the gyroscopic sensor is eliminated—can be acquired by use of ωX and ωY.

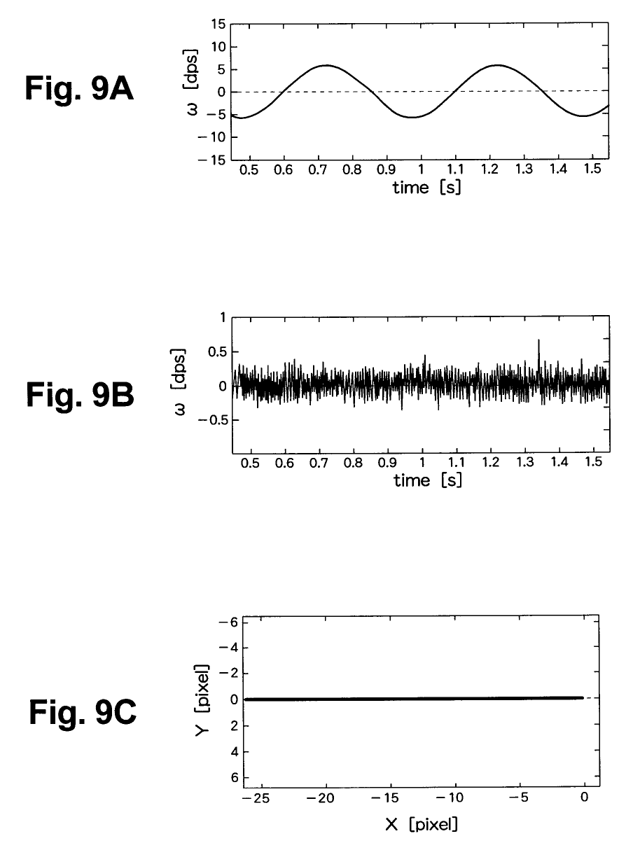

FIGS. 9A to 9C show changes in the gyroscopic sensors 14 and 16 with time and the locus of the point light source, which are acquired when the outputs from the gyroscopic sensors 14 and 16 are calibrated by use of the inclination K of the locus of the point light source in FIG. 7C. FIG. 9B shows changes with time in the gyroscopic sensor 16, and the inclination sin θ pitch is eliminated, so that a value of essentially zero is achieved. FIG. 9C shows a locus of the point light source, and the inclination is essentially zero.

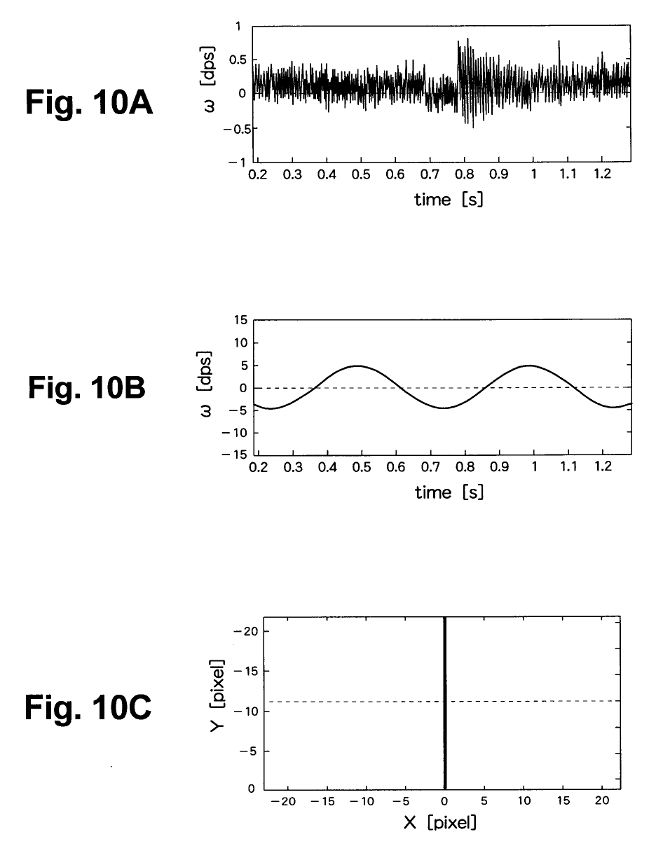

FIGS. 10A to 10C show changes with time in the gyroscopic sensors 14 and 16 and the locus of the point light source, which are acquired when outputs from the gyroscopic sensors 14 and 16 are calibrated by use of the inclination L of the locus of the point light source shown in FIG. 8C. FIG. 10C shows the locus of the point light source, and the inclination is likewise calibrated to nearly 90°.

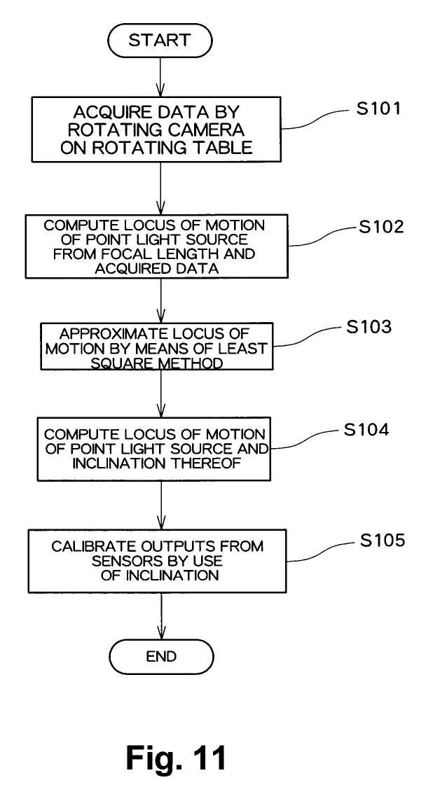

FIG. 11 shows a flowchart of basic processing mentioned above. First, the camera 12 is placed on the rotating table 10, and the rotating table 10 is rotated around a predetermined reference axis, whereby data output from the respective gyroscopic sensor 14 and 16 are acquired (S101). The motion of the camera 12 expressed as the locus (X, Y) of motion of the point light source on the imaging plane is computed from the focal length of the camera 12 and the acquired data. After computation of the locus of motion, the locus of motion is linearly approximated by means of the least square method, or the like (S103), and the inclination of the locus of motion is computed (S104). The outputs from the gyroscopic sensors 14 and 16 are calibrated on the basis of the thus-computed inclination (S105).

<Detection of the Inclination of the Image Sensor>

The inclinations of the gyroscopic sensors 14 and 16 can be detected as the inclination of the locus of the point light source on the imaging plane as mentioned above. There may also be a case where the accuracy of attachment of the image sensor is low and the image sensor is inclined. In such a case where the inclinations of the gyroscopic sensors 14 and 16 are not inclinations in absolute coordinates (coordinates by reference to the vertical direction and the horizontal direction), and angles of inclinations relative to the image sensor must be determined. In the present embodiment, there will now be described processing using an image including signals of all frequency domains photographed by the rotating camera 12; for instance, a CZP (Circular Zone Plate) chart image in a case where both the gyroscopic sensors 14 and 16 and the imager sensor are inclined.

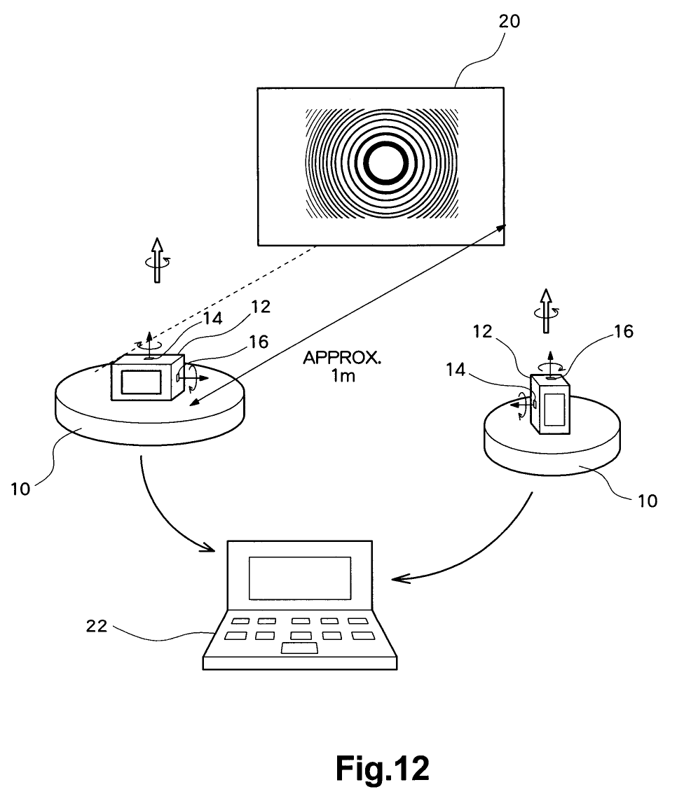

FIG. 12 shows an embodiment where the inclination of the image sensor can also be calibrated. Like the embodiment where the inclination of the gyroscopic sensor is calibrated, the camera 12 is placed on the rotating table 10, and the rotating table 10 is rotated in the yaw direction as well as in the pitch direction. The camera 12 is equipped with the gyroscopic sensor 14 for detecting an angular velocity of the yaw direction and the gyroscopic sensor 16 for detecting an angular velocity of the pitch direction. The sensors detect an angular velocity in the yaw direction and an angular velocity in the pitch direction, which are associated with rotation of the rotating table 10. In the drawing, as in the case of a general designation, a rotation around a center axis (a Y axis) penetrating through upper and lower surfaces of the camera 12 is taken as a rotation in the yaw direction, and a rotation around a center axis (an X axis) penetrating through the right-side surface and the left-side surface of the camera 12 is taken as a rotation in the pitch direction. Angular velocities are detected by means of the gyroscopic sensors 14 and 16, and a CZP chart 20 is photographed by the camera 12. Although a distance between the rotating table 10 and the CZP chart 20 is arbitrary, a photographing distance including a Nyquist frequency is preferable. An obtained image is an image deteriorated by the shake stemming from rotation. Outputs from the gyroscopic sensors 14 and 16 and a photographed image (a RAW image or a JPEG compressed image) are supplied to a computer 22. The computer 22 detects the inclinations of the gyroscopic sensors 14 and 16 with respect to the image sensor by use of these sets of data, and the outputs from the gyroscopic sensors 14 and 16 are calibrated on the basis of the detected inclinations.

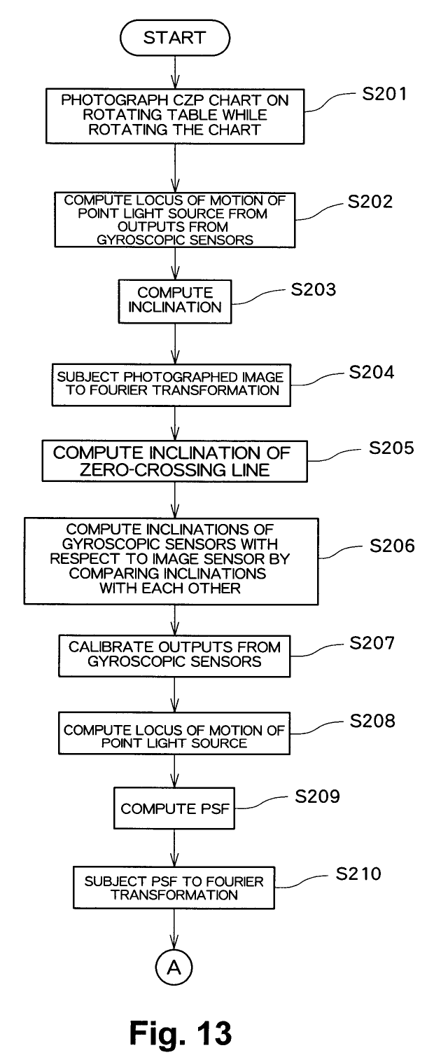

FIG. 13 shows a detailed processing flowchart of the present embodiment. First, the camera 12 is placed on the rotating table 10, and the CZP chart 20 is photographed while the rotating table 10 is being rotated. The angular velocity ωyaw of the yaw direction detected by the gyroscopic sensor 14 during rotation, the angular velocity θpitch of the pitch direction detected by the gyroscopic sensor 16 during rotation, and the image photographed during rotation are supplied to the computer 22.

The computer 22 performs processing below, to thus detect angles of relative inclination between the image sensor and the gyroscopic sensors 14 and 16. Specifically, as described above, the motion of the camera is computed as the locus (X, Y) of motion of the point light source on the imaging plane, from ωyaw output from the gyroscopic sensor 14, ωpitch output from the gyroscopic sensor 16, the focal length “f” of the imaging lens, and the sampling frequency Δts (S202), and the inclination Y/X of the locus of motion is computed (S203). In relation to the locus X, a changing angle AO acquired during a minute period of time Δt is expressed as ωX×Δt. The amount of displacement Δx is determined by fΔθ, and the locus X achieved during the period of an exposure time is computed by an equation of X=ΣfΔθ. In more detail, provided that Sen. is the sensitivity of a gyroscopic sensor, Gain is a gain of the detecting circuit, Voffset is an offset voltage of the gyroscopic sensor, Vout is a voltage output from the gyroscopic sensor, and fs is a sampling frequency, the locus X is computed by

X=f/(Sen.×Gain)·π/180/fs·Σ(Vout−Voffset)(the same also applies to the locus Y)

### The thus-computed locus corresponds to the inclinations of the gyroscopic sensors 14 and 16 in the absolute coordinates.

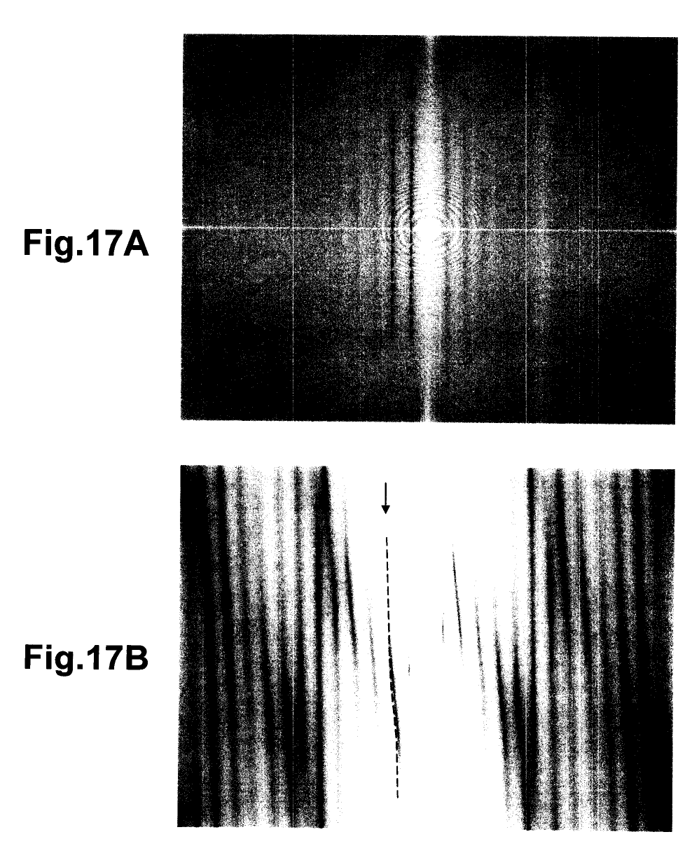

Meanwhile, the computer 22 detects the inclination of the image sensor from the photographed image of the CZP chart. Specifically, the photographed image of the CZP chart is subjected to Fourier transformation (S204), thereby extracting a zero-crossing line (see FIG. 17 and the like)—which is a line obtained by connecting the photographed image of the CZP chart with a zero-crossing point of the Fourier-transformed data—and computing the inclination of the zero-crossing line (S205). The zero-crossing line of the data into which the photographed image of the CZP chart has been Fourier-transformed becomes, unless the image sensor is inclined, parallel to the vertical direction (the direction Y) with regard to the rotation in the yaw direction and parallel to the horizontal direction (the direction X) with regard to the rotation in the pitch direction. However, when the image sensor is attached at an inclination with respect to the X-Y axis, the zero-crossing line becomes inclined, and the degree of inclination is dependent on the inclination of the image sensor. Accordingly, the angles of relative inclination of the gyroscopic sensors 14 and 16 with respect to the image sensor can be computed by comparing the inclination computed in S203 with the inclination computed in S205 (S206). When the two inclinations are equal to each other, no relative inclinations exist between the image sensor and the gyroscopic sensors 14 and 16, and calibration of the outputs from the gyroscopic sensors attributable to an inclination does not need to be performed. When the inclinations differ from each other, angles of relative inclination are computed by means of a subtraction of (the inclination of the locus of motion)—(the inclination of the zero-crossing line of the data into which the photographed image of the CZP chart has been Fourier-transformed). For instance, in connection with the rotation in the yaw direction (around the Y axis), θpitch which is the inclination of the gyroscopic sensor 16 is computed from the locus of motion. The inclination θ of the image sensor is detected from the inclination of the zero-crossing line of the data—into which the photographed image of the CZP chart has been Fourier-transformed—with respect to the Y axis. An angle θyaw′ of relative inclination of the gyroscopic sensor 16 with respect to the image sensor is detected by computing a difference between the detected inclination and the computed inclination. Likewise, in connection with the rotation in the pitch direction (around the X axis), θyaw which is the inclination of the gyroscopic sensor 14 is computed from the locus of motion. The inclination of the image sensor is detected from the inclination of the zero-crossing line of the data—into which the photographed image of the CZP chart has been Fourier-transformed—with respect to the X axis. An angle θpitch′ of relative inclination of the gyroscopic sensor 14 with respect to the image sensor is detected by computing a difference between the detected inclination and the computed inclination.

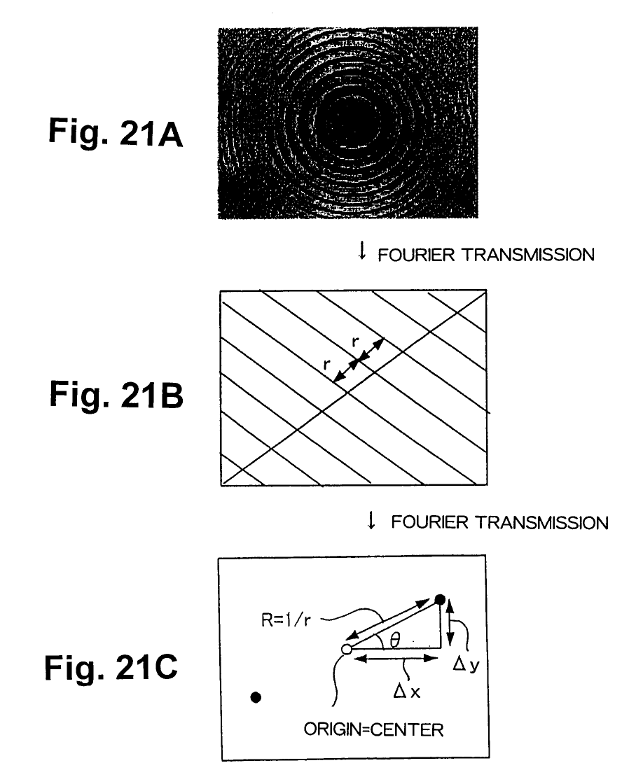

Processing pertaining to S205; namely, determination of the inclination of the zero-crossing line of the data into which the photographed image of the CZP chart has been Fourier-transformed, can be performed by subjecting the photographed image of the CZP chart to Fourier transformation and subjecting the resultantly-acquired data further to Fourier transformation. FIG. 21 shows a result achieved by means of subjecting a photographed image of a CZP chart (FIG. 21A) to Fourier transformation (FIG. 21B) and subjecting the resultant data further to Fourier transformation (FIG. 21C). Although the zero-crossing line should originally have an inclination of 0 because contrast achieved over the entire frequency domain is constant, an inclination arises in the zero-crossing line because the image sensor is inclined. The data—into which the photographed image of the CZP chart has been Fourier-transformed—are further subjected to Fourier transformation, and the resultant data are plotted, whereby a point where brightness assumes a value of zero appears as a peak. The inclination θ of the image sensor is computed as tan θ=Δy/Δx. The inclination θ of the image sensor can also be determined by subjecting a photographed image of a CZP chart to Fourier transformation and subjecting the resultant data to Hough transformation, in addition to subjecting the photographed image of the CZP chart to Fourier transformation and subjecting the resultant data further to Fourier transformation. In this case, θ appears as the inclination of a straight line on the Hough-transformed data. Hough transformation is more preferable than Fourier transformation, because the Hough transformation involves a smaller amount of computation.

After the angles θpitch′ and θyaw′ of relative inclination of the gyroscopic sensors 14 and 16 with respect to the image sensor have been computed, outputs from the gyroscopic sensors 14 and 16 are calibrated by use of the angles of inclination. Specifically, the outputs from the gyroscopic sensors 14 and 16 are calibrated by use of

ωX=(−ωyawsinθpitch′+ωpitchcosθyaw′)/cos(θyaw′+θpitch′) and

ωY=(ωyawcosθpitch′−ωpitchsinθyaw′)/cos(θyaw+θpitch′)(S207).

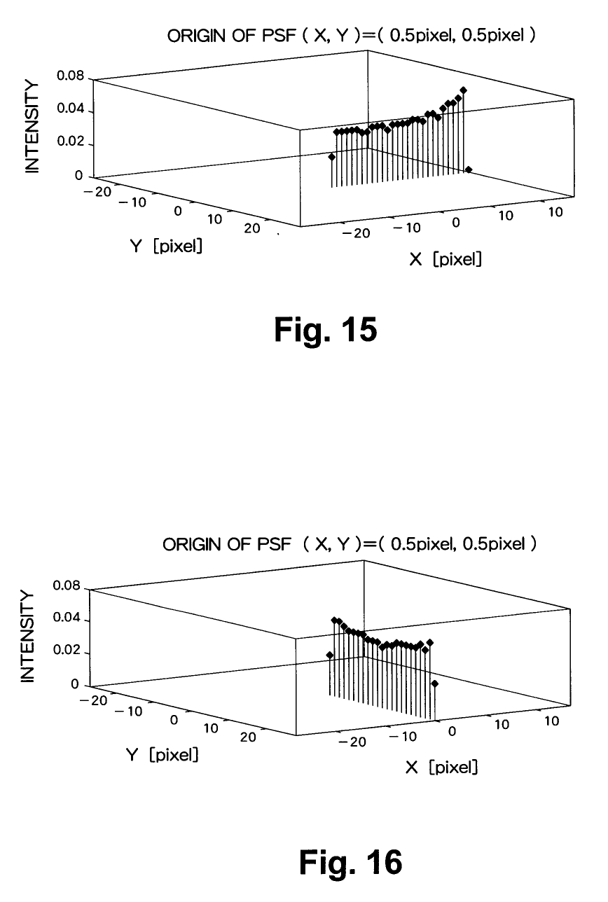

As mentioned previously, θyaw′ computed in S206 is an angle of relative inclination of the gyroscopic sensor 14 with respect to the image sensor, and θpitch′ computed in S206 is an angle of relative inclination of the gyroscopic sensor 16 with respect to the image sensor. Put another way, θyaw′ and θpitch′ are angles of inclination of the X and Y directions of the image sensor with respect to the detection axes of the gyroscopic sensors 14 and 16. After the outputs from the gyroscopic sensors 14 and 16 have been calibrated, the locus of motion of the point light source is recomputed from the calibrated outputs (S208). The PSF is computed from the locus of motion (S209). As mentioned previously, the PSF is an expression of the locus of motion as a brightness distribution function for each of the pixels of the image sensor, and a matrix size is determined according to an area of the locus of motion. FIGS. 15 and 16 show an example PSF. FIG. 15 shows a PSF pertaining to the locus of motion of the point light source (the locus of motion acquired after calibration of the outputs performed in S207) acquired when the rotating table 10 is rotated in the yaw direction (around the Y axis). FIG. 16 shows a PSF pertaining to the locus of motion of a point light source (the locus of motion acquired after calibration of the outputs performed in S207) achieved when the rotating table 10 is rotated in the pitch direction (around the X axis). Each of the points shows intensity at the position (X, Y) of a pixel. After computation of a PSF, the computer 22 subjects the computed PSF further to Fourier transformation (S210).

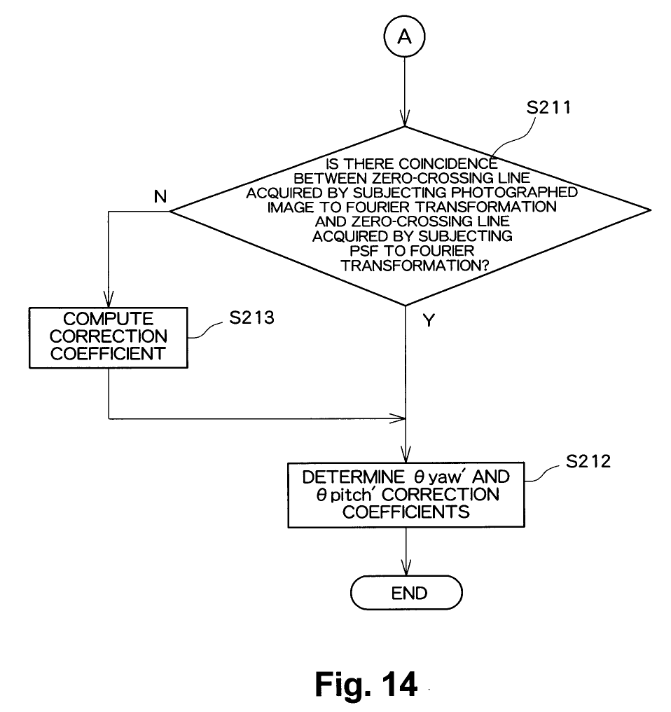

As shown in FIG. 14, the zero-crossing line of the data into which the PSF acquired in S201 has been Fourier-transformed is compared with the zero-crossing line, acquired in S202 or S203, of the data into which the photographed image of the CZP chart has been Fourier-transformed, thereby determining whether or not a coincidence exists between the zero-crossing lines (S211). The photographed image of the CZP chart is deteriorated by action of the PSF that serves as a deterioration function, and the influence of deterioration appears as a change in a frequency component of the photographed image. Therefore, if the PSF computed from the locus of motion determined by calibration of the outputs is a correct PSF, the zero-crossing line of the data into which the photographed image of the CZP chart has been Fourier-transformed has to coincide with the zero-crossing line of the data into which the PSF has been Fourier-transformed. When the result of determination rendered in S211 shows a coincidence between the zero-crossing lines (i.e., presence of a uniform line interval), the PSF computed in S209 is a correct PSF. Angles θyaw′ and θpitch′ of relative inclination of the gyroscopic sensors 14 and 16 are determined on the assumption that calibration of the outputs from the gyroscopic sensors 14 and 16 is correct (S212). The thus-determined θyaw′ and θpitch′ are stored in advance in, e.g., ROM of the camera 12, and used for calibrating outputs from gyroscopic sensors when the user actually performs photographing.

FIG. 17A shows a result of Fourier transformation of a photographed image of a CZP chart achieved when the camera 12 is rotated in the yaw direction, and FIG. 17B shows a result of Fourier transformation of the PSF performed before calibration of outputs from the gyroscopic sensors 14 and 16 when the camera 12 is rotated in the yaw direction. In these drawings, the zero-crossing lines are designated by broken lines. Since the zero-crossing line of the image data is vertical, the image sensor is understood to have no inclination. However, the result of Fourier transformation of the PSF shows a twist in the zero-crossing line, and no coincidence exists between the two zero-crossing lines. When the degree of accuracy of the PSF is high, a coincidence has to exist between the zero-crossing line acquired by Fourier-transformation of the photographed image of the CZP chart and the zero-crossing line of the image data. Therefore, the twist signifies that the PSF is not correct or that the gyroscopic sensors 14 and 16 are inclined.

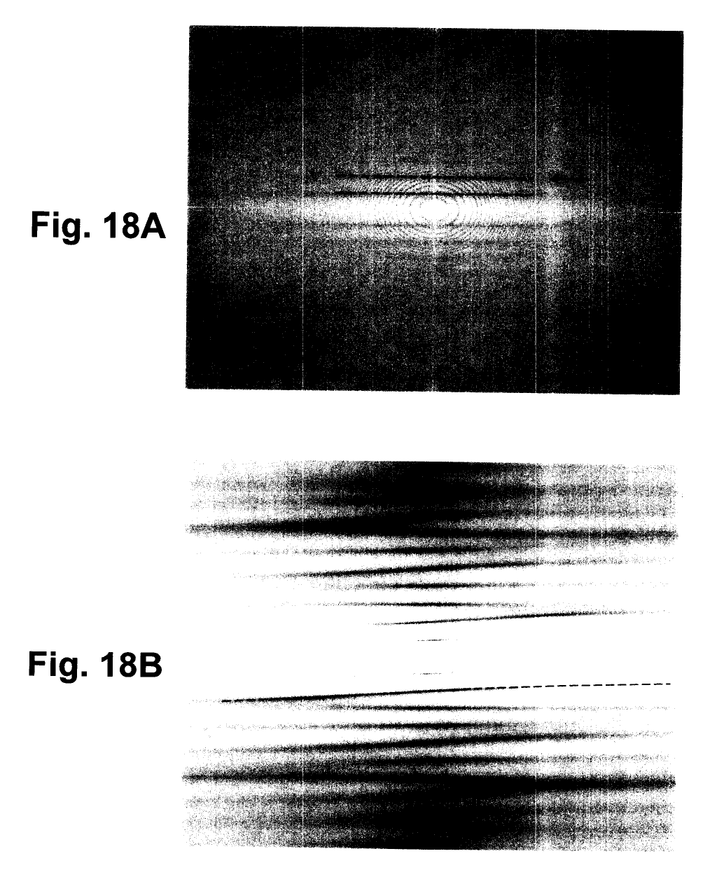

FIG. 18A shows a result of Fourier transformation of a photographed image of a CZP chart acquired when the camera 12 is rotated in the pitch direction. FIG. 18B shows a result of Fourier transformation of the PSF acquired before calibration of outputs from the gyroscopic sensors 14 and 16 when the camera 12 is rotated in the pitch direction. In these drawings, the zero-crossing lines are depicted by broken lines. As shown in FIG. 18B, a twist exists in the zero-crossing line of the data into which the PSF has been Fourier-transformed, and hence the necessity for calibration of the twist is understood.

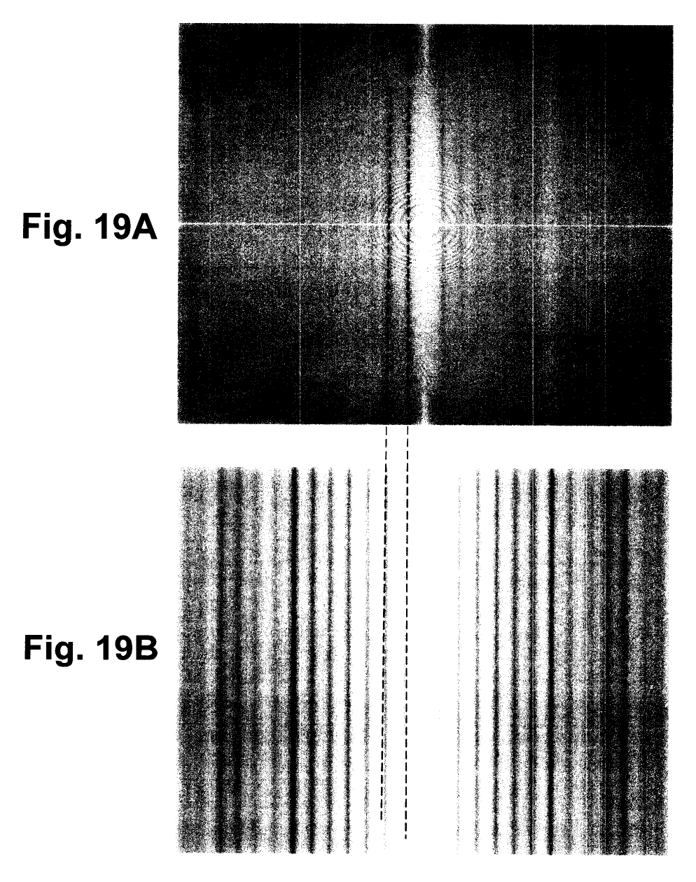

FIG. 19A shows a result of Fourier transformation of a photographed image of a CZP chart acquired when the camera 12 is rotated in the yaw direction. FIG. 19B shows a result of Fourier transformation of the PSF acquired by calibration of outputs from the gyroscopic sensors 14 and 16 when the camera 12 is rotated in the yaw direction. In these drawings, the zero-crossing lines are depicted by broken lines. The inclinations of both zero-crossing lines are vertical, and the widths of the zero-crossing lines essentially coincide with each other. The PSF is understood to have been made appropriate through calibration.

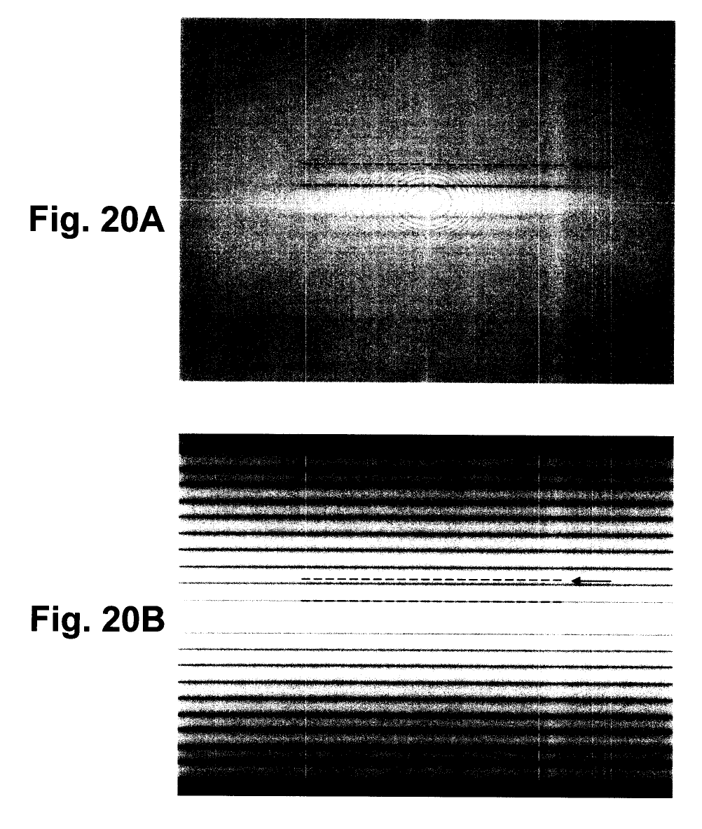

FIG. 20A shows a result of Fourier transformation of a photographed image of a CZP chart acquired when the camera 12 is rotated in the pitch direction. FIG. 20B shows a result of Fourier transformation of the PSF acquired by calibration of outputs from the gyroscopic sensors 14 and 16 when the camera 12 is rotated in the pitch direction. In these drawings, the zero-crossing lines are depicted by broken lines. The inclinations of both zero-crossing lines are horizontal, and the widths of the zero-crossing lines essentially coincide with each other. Even in this case, the PSF is understood to have been made appropriate through calibration.

Meanwhile, when the widths of the zero-crossing lines do not coincide with each other, there is a potential of the PSF computed through mathematical operation being influenced by an error other than at least either the inclination of the angular velocity sensor or the inclination of the image sensor. A correction coefficient is computed such that an interval between the zero-crossing lines achieved by Fourier transformation of the PSF coincides with the zero-crossing line achieved by Fourier transformation of the photographed image of the CZP chart that is a value (a true value) acquired as an actually-measured value (S213). Conceivable reasons for a mismatch between the zero-crossing lines include errors such as an error of sensor sensitivity between the gyroscopic sensors 14 and 16, a gain error of the detecting circuit, and an error of focal length of the photographing lens. Correction for achieving a coincidence between the zero-crossing lines means cancellation of the sum of influences attributable to these errors. Provided that the correction coefficient is taken as C, the interval between zero-crossing lines achieved by Fourier transformation of a PSF is taken as “a,” and the width of the zero-crossing line acquired by Fourier-transformation of the photographed image of the CZP chart is taken as “b,” the correction coefficient C is computed by C=b/a, and the thus-computed coefficient is recorded in ROM, or the like, in the camera. When computing the motion of the camera as the locus of motion of the point light source on an imaging plane (when determining, e.g., the locus X), the camera having the correction coefficient recorded therein performs computation by use of a value calibrated according to an equation of

X=C·f/(Sen.×Gain)·π/180/fs·Σ(Vout−Voffset), wherein

f: a focal length of the photographing lens

### Sen.: sensor sensitivity

### Gain: a gain of the detecting circuit

fs: a sampling frequency

### Vout: a sensor output, and

### Voffset: an offset voltage (computed by another means).

In relation to the data shown in FIGS. 19 and 20, the widths of the zero-crossing data are deemed to essentially coincide with each other, and hence procedures for computing the correction coefficient C do not need to be performed.

### PARTS LIST

10 rotating table
12 camera
14 gyroscopic sensor
16 gyroscopic sensor
18 gyroscopic sensor
20 CZP chart
22 computer
100 arrow

What is claimed is:

1. A method for calibrating an angular velocity detection axis in a camera having an angular velocity detection system, the method comprising the steps of:
computing motion of the camera as a locus of motion of a point light source on an imaging plane from an angular velocity output acquired when the camera is rotated around a reference axis;
computing an inclination of the locus of motion; and
calibrating an output from the angular velocity sensor in accordance with the inclination.

2. The method according to claim 1, further comprising the steps of:
computing a point spread function (PSF) from the locus of motion acquired by calibration of the angular velocity output;
subjecting the PSF to Fourier transformation; and
verifying calibration of the angular velocity output by use of a zero-crossing point of data into which the PSF has been Fourier-transformed.

3. The method according to claim 2, further comprising the step of:
photographing an image when the camera is rotated, wherein the verification step is to verify calibration of the angular velocity output by means of comparing a zero-crossing point of the data into which an image photographed when the camera is rotated around the reference axis has been Fourier-transformed with a zero-crossing point of the data into which the PSF has been Fourier-transformed.

4. The method according to any one of claim 1, wherein the calibration step is to compute an angle of inclination of the angular velocity detection axis from the inclination of the locus of motion and to calibrate the angular velocity output in accordance with the angle of inclination.

5. The method according to claim 1, further comprising the step of:
photographing an image when the camera is rotated, wherein the calibration step is to compute an angle of relative inclination of the angular velocity detection axis with respect to the image sensor from the inclination of the image sensor acquired from the inclination of the locus of motion and data acquired by subjecting the image to image analysis and to calibrate the angular velocity output from the angle of inclination.

6. The method according to claim 5, wherein the image analysis is Fourier transformation.

7. The method according to claim 6, wherein data into which the image has been Fourier-transformed are further subjected to Fourier transformation, and an inclination of the image sensor is determined from the thus-transformed data.

8. The method according to claim 6, wherein the image having been Fourier-transformed are subjected further to Hough transform, and an inclination of the image sensor is determined from the Hough-transformed data.

9. An angular velocity calibration method comprising the steps of:
acquiring outputs from angular velocity sensors for detecting an angular velocity around an X axis and an angular velocity around a Y axis when a camera is rotated around the X axis penetrating through the camera horizontally and the Y axis which is perpendicular to the X axis and which penetrates through the camera vertically;
photographing a predetermined image during rotation of the camera;
computing motion of the camera from the output as a locus of motion of a point light source on an imaging plane;
computing inclination of the angular velocity sensor from the inclination of the locus of motion;
computing inclination of an image sensor of the camera from the photographed image;
computing an angle of relative inclination of the angle of the angular velocity sensor with respect to the image sensor, from the inclination of the image sensor and the inclination of the angular velocity sensor;
calibrating outputs from the angular velocity sensor from the angle of relative inclination; and
recomputing the locus of motion of the point of light source on the imaging sensor from the calibrated output from the angular velocity sensor, to thus further compute a PSF.
